(19) United States
(12) Patent Application Publication
(10) Pub. No.: US 2018/0265022 A1
(43) Pub. Date: Sep. 20, 2018

(54) IN-VEHICLE POWER SUPPLY DEVICE

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventor: Hayato Fukushima, Yokkaichi, Mie (JP)

(21) Appl. No.: 15/762,770

(22) PCT Filed: Sep. 6, 2016
(86) PCT No.: PCT/JP2016/076063

§ 371 Date: Mar. 23, 2018

(30) Foreign Application Priority Data
Sep. 25, 2015 (JP) 2015-188201

(51) Int. Cl. B60R 16/033; B60R 16/02; H01M 10/44

(52) U.S. Cl. CPC B60R 16/033; H02J 7/14; H01M 10/441; B60R 16/0207

(57) ABSTRACT

The present invention provides an in-vehicle power supply device that suppresses a decrease in the supply voltage supplied to a first load caused by the current supplied to a second load. A first wiring line connects the first load and a main power storage device. A second wiring line connects the first load and a sub power storage device. The resistance value of the second wiring line is smaller than the resistance value of the first wiring line. A third wiring line connects the second load and the main power storage device. A fourth wiring line connects the second load and the sub power storage device. The resistance value of the fourth wiring line is larger than the resistance value of the third wiring line.

### CROSS-REFERENCE TO RELATED APPLICATIONS

This application is the U.S. national stage of PCT/JP2016/076063 filed Jun. 9, 2016, which claims priority of Japanese Patent Application No. JP 2015-188201 filed on Sep. 25, 2015.

### TECHNICAL FIELD

This invention relates to an in-vehicle power supply device.

### BACKGROUND

JP 2011-155791A discloses a vehicle power supply device that has a battery and a power storage unit. The battery and the power storage unit are charged by a generator and supply power to loads. A switch is provided between the battery and the loads. A control circuit that controls this switch is also provided.

It is conceivable that the control circuit also receives power from the battery and the power storage unit. In this structure, if the voltage of the battery and the power storage unit decreases due to the flow of current to the loads, the supply voltage that is applied to the control circuit decreases as well. If this supply voltage falls below the lower limit voltage value of the control circuit, the control circuit cannot operate. Accordingly, such a decrease in the supply voltage is not desirable.

To give a more general description, in a structure in which power is supplied from two power storage devices to a first load and a second load, it is not desirable that the supply voltage supplied to the first load decreases a large amount due to the current supplied to the second load.

In view of this, an object of the present invention is to provide an in-vehicle power supply device that suppresses a decrease in the supply voltage supplied to a first load caused by the current supplied to a second load.

### SUMMARY

An in-vehicle power supply device includes: a first wiring line that connects a first load and a first power storage device; a second wiring line that connects the first load and a second power storage device, and has a smaller resistance value than the first wiring line; a third wiring line that connects a second load and the first power storage device; and a fourth wiring line that connects the second load and the second power storage device, and has a larger resistance value than the third wiring line, wherein an internal resistance of the second power storage device is smaller than an internal resistance of the first power storage device, and a maximum value of current that flows in the second load is larger than a maximum value of current that flows in the first load.

According to this in-vehicle power supply device, it is possible to suppress a decrease in the supply voltage supplied to a first load caused by the current supplied to a second load.

### BRIEF DESCRIPTION OF DRAWINGS

FIG. 1 is a diagram schematically showing an example of a configuration of an in-vehicle power supply device.

FIG. 2 is a diagram schematically showing an example of an equivalent circuit of the in-vehicle power supply device.

FIG. 3 is a diagram schematically showing an example of an equivalent circuit according to a comparative example.

### DETAILED DESCRIPTION OF PREFERRED EMBODIMENTS

Configuration of In-Vehicle Power Supply Device

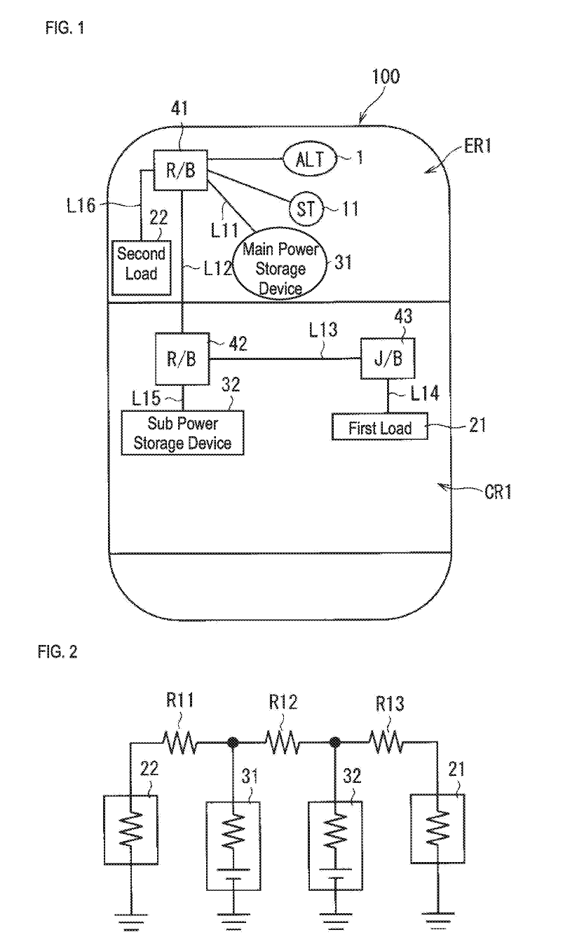

FIG. 1 is a diagram schematically showing an example of the configuration of an in-vehicle power supply device 100 for installation in a vehicle. As shown in FIG. 1, a generator 1 and a starter 11 are provided. The starter 11 is a motor for starting an engine that is not shown, and is indicated by “ST” in FIG. 1. The generator 1 is an alternator, for example, and is indicated by “ALT” in FIG. 1. The generator 1 generates power based on drive power for driving the vehicle, and outputs DC voltage. This drive power can be obtained by the engine, for example.

As shown in FIG. 1, the generator 1 and the starter 11 are connected to a main power storage device 31 via a relay box 41, for example. The relay box 41 appropriately selects connection or disconnection between components that are connected to the relay box 41. In FIG. 1, the relay box 41 is indicated by “R/B”. As shown in FIG. 1, the relay box 41 is also connected to a relay box 42 and a second load 22, and appropriately selects connection or disconnection between the generator 1, the starter 11, the main power storage device 31, the second load 22, and the relay box 42. The main power storage device 31 is charged by the generator 1 via the relay box 41. A lead storage battery is applied as the main power storage device 31, for example.

As shown in FIG. 1, a sub power storage device 32 is connected to the generator 1 via the relay boxes 41 and 42, for example. The relay box 42 selects connection or disconnection between components that are connected to the relay box 42, and is indicated by “R/B” in FIG. 1. The relay box 42 is also connected to the sub power storage device 32, and selects connection or disconnection between the relay box 41, the sub power storage device 32, and a junction box 43. A lithium ion battery, a nickel hydrogen battery, a capacitor, or the like can be applied as the sub power storage device 32. This sub power storage device 32 is charged by the generator 1 and the main power storage device 31 via the relay boxes 41 and 42.

The main power storage device 31 is also connected to a first load 21 via the relay boxes 41 and 42 and the junction box 43, for example. The first load 21 is an in-vehicle ECU (Electronic Control Unit), for example. The junction box 43 appropriately selects connection or disconnection between components that are connected to the junction box 43, and is indicated by “J/B” in FIG. 1. The junction box 43 appropriately selects connection or disconnection between the relay box 42 and the first load 21. Note that the relay boxes 41 and 42 and the junction box 43 are appropriately provided with relays, and may be further provided with fuses.

The main power storage device 31 supplies power to the first load 21 via the relay boxes 41 and 42 and the junction box 43, and the sub power storage device 32 supplies power to the first load 21 via the relay box 42 and the junction box 43.

The second load 22 is connected to the main power storage device 31 via the relay box 41, for example. The second load 22 is a motor for steering, for example. Note that although the starter 11 is shown as a separate component from the second load 22 in FIG. 1, the starter 11 may be applied as the second load 22. The main power storage device 31 supplies power to the second load 22 via the relay box 41, and the sub power storage device 32 supplies power to the load 22 via the relay boxes 41 and 42.

As shown in FIG. 1, the relay box 41 and the main power storage device 31 are connected to each other by a wiring line L11, the relay boxes 41 and 42 are connected to each other by a wiring line L12, the relay box 42 and the junction box 43 are connected to each other by a wiring line L13, and the junction box 43 and the first load 21 are connected to each other by a wiring line L14. Hereinafter, the wiring lines L11 to L14 will also be collectively called a wiring line L1. This wiring line L1 connects the first load 21 and the main power storage device 31 to each other.

The relay box 42 and the sub power storage device 32 are connected by a wiring line L15. Hereinafter, the wiring lines L13 to L15 will also be collectively called a wiring line L2. This wiring line L2 connects the sub power storage device 32 and the first load 21 to each other.

The relay box 41 and the second load 22 are connected to each other by a wiring line L16. Hereinafter, the wiring lines L11 and L16 will also be collectively called a wiring line L3. This wiring line L3 connects the main power storage device 31 and the second load 22 to each other. Also, hereinafter, the wiring lines L12, L15, and L16 will also be collectively called a wiring line L4. This wiring line L4 connects the sub power storage device 32 and the second load 22 to each other.

The wiring lines L1 to L4 form a wiring group for in-vehicle power supply. The wiring lines L1 to L4 are wire harnesses, for example, and the resistance value thereof is larger than the resistance value of the relay boxes 41 and 42 and the junction box 43. For example, the resistance value of the wiring lines L1 to L4 is approximately 10 to 100 times that of the relay boxes 41 and 42 and the junction box 43. Accordingly, when considering the resistance values of paths, it is sufficient to mainly consider the resistance value of the wiring lines L1 to L4.

In the present embodiment, the resistance value of the wiring line L2 (L13 to L15) that connects the first load 21 and the sub power storage device 32 to each other is smaller than the resistance value of the wiring line L1 (L11 to L14) that connects the first load 21 and the main power storage device 31 to each other. As shown in FIG. 1, the wiring lines L13 and L14 from the first load 21 to the relay box 42 are included in both the wiring lines L1 (L11 to L14) and L2 (L13 to L15), and therefore the magnitude relationship between the resistance values of the wiring lines L1 and L2 is determined by the combined resistance value of the wiring lines L11 and L12 and by the resistance value of the wiring line L15. Accordingly, by setting the resistance value of the wiring line L15 smaller than the combined resistance value of the wiring lines L11 and L12, it is possible to set the resistance value of the wiring line L2 smaller than the resistance value of the wiring line L1.

Also, the resistance value of the wiring line L4 (L12, L15, and L16) that connects the second load 22 and the sub power storage device 32 to each other is larger than the resistance value of the wiring line L3 (L11 and L16) that connects the second load 22 and the main power storage device 31 to each other. As shown in FIG. 1, the wiring line L16 from the second load 22 to the relay box 41 is included in both the wiring lines L3 (L11 and L16) and L4 (L12, L15, and L16), and therefore the magnitude relationship between the resistance values of the wiring lines L3 and L4 is determined by the resistance value of the wiring line L11 and by the combined resistance value of the wiring lines L12 and L15. Accordingly, by setting the combined resistance value of the wiring lines L12 and L15 larger than the resistance value of the wiring line L11, it is possible to set the resistance value of the wiring line L4 larger than the resistance value of the wiring line L3.

If the resistance values of the wiring lines L11, L12, and L15 are perceived in terms of length, the wiring lines L11, L12, and L15 satisfy the above-described conditions if a triangle is drawn with these resistance values as the sides, for example. The above-described conditions are also satisfied when the expressions [wiring line L12 resistance value>>wiring line L11 resistance value] and [wiring line L12 resistance value>>wiring line L15 resistance value] hold true.

FIG. 2 is a diagram schematically showing an example of an equivalent circuit of the in-vehicle power supply device. FIG. 2 shows an example of the connection relationship between the main power storage device 31, the sub power storage device 32, the first load 21 and the second load 22. In FIG. 2, the wiring lines that connect the main power storage device 31, the sub power storage device 32, the first load 21 and the second load 22 to each other are indicated by resistances R11 to R13, and the generator 1, the starter 11, the relay boxes 41 and 42, and the junction box 43 are not shown. FIG. 2 also shows internal resistances of the main power storage device 31 and the sub power storage device 32, and the first load 21 and the second load 22 are also indicated by resistances.

As shown in FIG. 2, one end of each of the first load 21, the second load 22, the main power storage device 31, and the sub power storage device 32 is grounded. The resistance R11 is connected between the other end of the main power storage device 31 and the other end of the second load 22, the resistance R12 is connected to the other end of the main power storage device 31 and the other end of the sub power storage device 32, and the resistance R13 is connected between the other end of the sub power storage device 32 and the other end of the first load 21. The resistances R12 and R13 correspond to the wiring line L1, the resistance R13 corresponds to the wiring line L2, the resistance R11 corresponds to the wiring line L3, and the resistances R11 and R12 correspond to the wiring line L4.

As shown in FIG. 2, the resistance value of the wiring line L2 (the resistance value of the resistance R13) is smaller than the resistance value of the wiring line L1 (the combined resistance value of the resistances R12 and R13). In other words, the sub power storage device 32 is connected to the first load 21 by a wiring line that has a smaller resistance value than the wiring line between the main power storage device 31 and the first load 21.

Also, the resistance value of the wiring line L4 (the combined resistance value of the resistances R11 and R12) is larger than the resistance value of the wiring line L3 (the resistance value of the resistance R11). In other words, the sub power storage device 32 is connected to the second load 22 by a wiring line that has a larger resistance value than the wiring line between the main power storage device 31 and the second load 22.

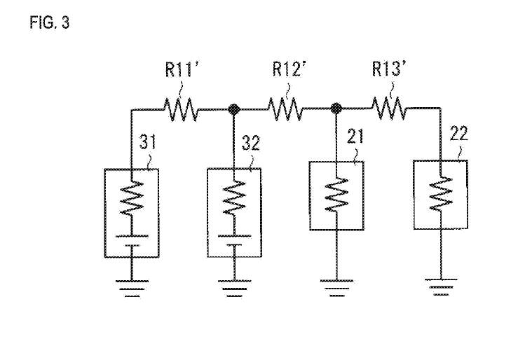

Advantages of this structure will be described below using a comparative example shown in FIG. 3. In the comparative example, a resistance R11′ is connected between the other end of the main power storage device 31 and the other end of the sub power storage device 32, a resistance R12′ is connected between the other end of the sub power storage device 32 and the other end of the first load 21, and a resistance R13′ is connected between the other end of the first load 21 and the other end of the second load 22.

Accordingly, similarly to the embodiment, the resistance value between the first load 21 and the sub power storage device 32 (=resistance value of resistance R12′) is smaller than the resistance value between the first load 21 and the main power storage device 31(=combined resistance value of resistances R11′ and R12′). However, unlike the present embodiment, the resistance value between the second load 22 and the sub power storage device 32(=combined resistance value of resistances R12′ and R13′) is also smaller than the resistance value between the second load 22 and the main power storage device 31(=combined resistance value of resistances R11′ to R13′).

Next, in the present embodiment and the comparative example, consider a drop in voltage that occurs in the internal resistances of the main power storage device 31 and the sub power storage device 32 due to the flow of current to the second load 22. In the comparative example (see FIG. 3), the main power storage device 31 is connected to the second load 22 by a wiring line that has a large resistance value (resistances R11′ to R13′), and the sub power storage device 32 is connected to the second load 22 by a wiring line that has a small resistance value (resistances R12′ and R13′). Accordingly, from the viewpoint of the magnitude relationship between the resistance values of the wiring lines, the amount of current that flows from the sub power storage device 32 to the second load 22 is larger than the amount of current that flows from the main power storage device 31 to the second load 22. Accordingly, the voltage drop that occurs in the sub power storage device 32 is large.

Moreover, in the comparative example, the main power storage device 31 is connected to the first load 21 by a wiring line that has a large resistance value (resistances R11′ and R12′), and the sub power storage device is connected to the first load 21 by a wiring line that has a small resistance value (resistance R12′). Accordingly, the first load 21 is more likely to be subjected to voltage fluctuation from the sub power storage device 32 than to voltage fluctuation from the main power storage device 31.

As described above, in the comparative example, the first load 21 is more likely to be subjected to voltage fluctuation from the sub power storage device 32 that undergoes a large voltage drop due to current that flows to the second load 22. Therefore, according to the comparative example, a large decrease occurs in the supply voltage applied to the first load 21.

On the other hand, in the present embodiment (see FIG. 2), the main power storage device 31 is connected to the second load 22 by a wiring line that has a small resistance value (resistance R11), and the sub power storage device 32 is connected to the second load 22 by a wiring line that has a large resistance value (resistances R11 and R12). Accordingly, from the viewpoint of the magnitude relationship between the resistance values of the wiring lines, the current that flows from the sub power storage device 32 to the second load 22 is smaller than the current that flows from the main power storage device 31 to the second load 22. Accordingly, the voltage drop that occurs in the sub power storage device 32 is small.

Also, in the present embodiment as well, the main power storage device 31 is connected to the first load 21 by a wiring line that has a large resistance value (resistances R12 and R13), and the sub power storage device is connected to the first load 21 by a wiring line that has a small resistance value (resistance R13). Accordingly, the first load 21 is more likely to be subjected to voltage fluctuation from the sub power storage device 32 than to voltage fluctuation from the main power storage device 31.

As described above, according to the present embodiment, unlike the comparative example, the first load 21 is more likely to be subjected to voltage fluctuation from the sub power storage device 32 that undergoes a small voltage drop due to current that flows to the second load 22. Therefore, in comparison with the comparative example, it is possible to suppress a decrease occurs in the supply voltage applied to the first load 21. According to this configuration, a load that has a small tolerance value with respect to a decrease in supply voltage can be applied as the first load 21. For example, an in-vehicle ECU has a small tolerance value with respect to a decrease in supply voltage, and such an in-vehicle ECU can be applied as the first load 21.

As one example, the following describes the case where a large current flows to the second load. For example, the starter 11 is applies as the second load 22. Even after the engine is stopped in order to perform idling stop, power is supplied to the first load 21 (in-vehicle ECU). When power is then supplied to the second load 22 (the starter 11) in order to start the engine, a relatively large amount of current flows to the second load 22. In this case, a voltage drop occurs in the main power storage device 31 and the sub power storage device 32, but as described above, it is possible to suppress a decrease in the supply voltage applied to the first load 21. Accordingly, it is possible to suppress an interruption in the operation of the first load 21 when the engine is started from the idling stop state.

Internal Resistances of Power Storage Devices

It is desirable that the internal resistance value of the sub power storage device 32 is smaller than the internal resistance value of the main power storage device 31. Compared with the main power storage device 31 that has a large internal resistance value, in the sub power storage device 32 that has a small internal resistance value, a smaller voltage drop occurs with respect to the same current. Accordingly, the voltage drop in the sub power storage device 32 is smaller than the voltage drop in the main power storage device 31.

Accordingly, it is possible to further reduce the amount of voltage drop that occurs in the sub power storage device 32 due to current that flows to the second load 22. It is therefore possible to further suppress a decrease in the supply voltage applied to the first load 21 caused by current supplied to the second load 22.

Current in First Load 21 and Second Load 22

The maximum value of current that flows in the second load 22 is larger than the maximum value of current that flows to the first load 21. Specifically, the sub power storage device 32, which has a small internal resistance, is connected to the second load 22, which can handle a large current, with a large resistance value. For example, the in-vehicle ECU is applied as the first load 21, and a motor for steering or the starter 11 is applied as the second load 22.

The voltage drop that occurs in the main power storage device 31 and the sub power storage device 32 increases as the current flowing therein increases. Specifically, when current flows to the second load 22, the voltage drop that occurs in the main power storage device 31 and the sub power storage device 32 is large. In order to suppress a decrease in the voltage applied to the first load 21, it is desirable that the sub power storage device 32 having a smaller internal resistance is connected to the second load 22 by a wiring line that has a larger resistance value than the wiring line between the main power storage device 31 and the second load 22. This is because this makes it possible to reduce the amount of current that flows in the sub power storage device 32. Accordingly, it is possible to the reduce the amount of voltage drop that occurs in the sub power storage device 32, and it is possible to suppress a decrease in the voltage applied to the first load 21.

As described above, by setting a small current load as the first load 21 that is connected to the sub power storage device 32 having a small internal resistance by a wiring line having a small resistance value, and setting a large current load as the second load 22 that is connected to the main power storage device 31 having a large internal resistance by a wiring line having a small resistance value, it is possible to suppress a decrease in the supply voltage that is applied to the first load 21 in comparison with the opposite case.

Arrangement

In FIG. 1, the main power storage device 31, the second load 22 and the relay box 41 are arranged on an engine room ER1 side at the front of the vehicle, and the sub power storage device 32, the first load 21, the relay box 42, and the junction box 43 are arranged on a compartment CR1 side that is behind the engine room ER1.

Also, the relay box 41 connects the main power storage device 31 to the second load 22 on the engine room ER1 side, and the relay box 42 connects the sub power storage device 32 to the junction box 43 and thus the second load 22 on the compartment CR1 side. In this manner, the main power storage device 31 is connected to the second load 22 on the engine room ER1 side, which is the same side as the second load 22, and therefore these components can be easily connected by a short wiring line. Similarly, the sub power storage device 32 is connected to the first load 21 on the compartment CR1 side, which is the same side as the first load 21, and therefore these components can be easily connected by a short wiring line.

Also, the relay boxes 41 and 42 are connected to each other by the wiring line L12 while also being respectively provided on the engine room ER1 side and the compartment CR1 side. Note that although the engine room ER1 and the compartment CR1 are divided by a partition board, the wiring line L12 passes through this partition board.

Due to the relay boxes 41 and 42 being connected to each other, the main power storage device 31 and the first load 21 are connected to each other while also being respectively located on the engine room ER1 and the compartment CR1 side. Accordingly, these components are connected by a relatively long wiring line. Similarly, the sub power storage device 32 and the second load 22 are also connected by a relatively long wiring line.

Accordingly, with the arrangement in FIG. 1, the above-described resistance value relationship is easily satisfied.

The configurations described in the above embodiment and variations can be appropriately combined as long as no contradiction arises.

Although this invention has been described in detail above, the above description is illustrative in all respects, and this invention is not limited to the above description. It will be understood that numerous variations not illustrated here can be envisioned without departing from the range of this invention.

1. An in-vehicle power supply device comprising:
a first wiring line that connects a first load and a first power storage device;
a second wiring line that connects the first load and a second power storage device, and has a smaller resistance value than the first wiring line;
a third wiring line that connects a second load and the first power storage device; and
a fourth wiring line that connects the second load and the second power storage device, and has a larger resistance value than the third wiring line,
wherein an internal resistance of the second power storage device is smaller than an internal resistance of the first power storage device, and
a maximum value of current that flows in the second load is larger than a maximum value of current that flows in the first load.

2-3. (canceled)
